(19) United States
(12) Patent Application Publication
(10) Pub. No.: US 2023/0165228 A1
(43) Pub. Date: Jun. 1, 2023

(54) SYSTEM AND METHOD FOR A COLLAPSIBLE RECREATIONAL LOBSTER TRAP

(71) Applicant: Jordan David Brighi, Portland, ME (US)

(72) Inventor: Jordan David Brighi, Portland, ME (US)

(21) Appl. No.: 17/540,129

(22) Filed: Dec. 1, 2021

(51) Int. Cl. A01K 69/10

(52) U.S. Cl. CPC A01K 69/10

(57) ABSTRACT

The invention is a collapsible lobster trap configured to trap lobsters recreationally. The trap comprises a frame that may pull apart for transport and assemble for use, a netting that encloses the inside of the trap, an external entrance opening that allows lobsters to enter but not exit the trap, an inner funnel that allows a lobster to travel between two inner compartments of the trap, and an escape opening that enables users to remove lobsters from the trap.

### CROSS REFERENCE TO RELATED APPLICATIONS

Not applicable.

### STATEMENT REGARDING FEDERALLY SPONSORED RESEARCH

Not applicable.

### NAMES OF PARTIES TO A JOINT RESEARCH AGREEMENT

Not applicable.

### REFERENCE TO A SEQUENCE LISTING, TABLE, OR COMPUTER PROGRAM

Not Applicable

### BACKGROUND

### 1. Field of the Invention

The invention relates to a collapsible trap for catching marine life, particularly crustaceans. The present invention is devised particularly to trap lobsters. Additionally, the invention is made for easy assembly, disassembly, storing, and transport. The portable nature of the trap enables recreational lobster fishermen to easily transport the trap, including using a single-user watercraft.

### 2. Description of Related Art

A wide variety of collapsible crustacean traps are available for both recreational and commercial purposes. The collapsible nature of these crustacean traps facilitates easy transport and storage when collapsed and trapping of marine life when assembled.

Traps for lobsters are commonly referred to as lobster pots. Both recreational and commercial lobster pots comprise a rigid metal grid structure, and collapse by folding down onto themselves. The rigid, fused metal prevents the trap from collapsing to a size that is easy to maneuver on a single-user watercraft.

Other collapsible lobster pots are comprised of netting and a series of rigid metal rings to keep parts of the trap open for lobsters to enter. Many of those traps do not comply with local lobster pot standards because they do not include a ghost panel, which biodegrades and allows lobsters to escape if the trap is lost while fishing. Additionally, most mesh lobster pots do not include runners, which are elongated rods run along opposite sides of the bottom of a trap and prevent damage to caught lobsters' claws. Many recreational lobster fishing spots require ghost panels and runners on traps for the fisherman to use the traps. Runners are present to help protect the claws of caught lobsters in case the lobster must be released after being caught. For example, reproducing female lobsters must be released if caught to encourage regrowth of lobster populations.

Lobster traps often have two compartments; the “kitchen”, which contains an entrance opening from the outside of the trap and contains the bait that lures in a lobster, and the “parlor”, which a lobster may migrate to through an inner funnel between the compartments. Mesh traps also do not have these features.

Further, many crustacean pots are design to trap crabs. Those traps have only one internal compartment, and do not contain a ghost panel or an escape opening. Lobster traps often have two components so that a lobster that is trapped eventually migrates to a second compartment where it may be able to escape through a ghost hatch. Ghost hatches and escape openings are important in lobster traps to allow lobsters to exit the trap if the trap is not retrieved or is lost, which encourages growth of lobster populations. Many local lobster trap standards require the presence of a ghost hatch and escape opening be included in the trap.

So as to reduce the complexity and length of the Detailed Specification, and to fully establish the state of the art in certain areas of technology, Applicant(s) herein expressly incorporate(s) by reference all of the following materials identified in each numbered paragraph below.

The U.S. Pat. No. 8,015,748B2 patent relates to a collapsible trap. The invention claims to be a collapsible trap particularly suitable as a crab pot for trapping crabs. The collapsible trap comprises a frame structure having a central axis and pliant material such as netting attached to the frame structure. A haul line is connected to the frame structure. The frame structure comprises a plurality of elongate frame elements. The frame structure is moveable between a retracted condition in which the frame elements extend generally parallel to central axis and an extended condition in which the frame elements extend outwardly of the central axis giving form and shape to the netting to provide an enclosure defining an entrapment zone. When the frame structure is in the retracted condition, the netting can be wrapped about the frame structure to assume a compact condition for storage and transportation. In one arrangement, the enclosure is configured as a cage having several entry openings through which crabs can enter the enclosure, and an access way incorporating an opening for retrieval of crabs trapped within the enclosure.

The U.S. Pat. No. 4,864,770A patent relates to a collapsible crustacean trap. The invention claims to be an improved Collapsible Crustacean Trap is described which includes substantially rectangular top and bottom panels which are hinged to side panels. Each of the side panels is hinged in the middle so that it can move between a substantially vertical and a substantially horizontal position. Releasable connectors are provided for securing the panels in a rectangular box. A cover is provided, and an entrance for the crustacean is also provided.

The U.S. Pat. No. 5,839,220A patent related to a collapsible marine animal trap and storage unit. The invention claims to be a collapsible lobster trap having an external and internal design very similar to existing, non-collapsible traps, which allows a user to transport by truck, boat, or other means, a larger number of traps per excursion than is currently possible. The trap has a rectangular bottom panel to which a first pair of opposed side panels and a second pair of opposed side panels are hingedly attached. A top panel is hingedly attached to one of the side panels and is secured in the closed position by two retaining straps. In a preferred embodiment of the invention, each panel of one pair of opposed side panels is designed with ends overlapping the ends of the other pair of opposed side panels so that the vertical corners of the trap are structurally reinforced while maintaining collapsibility. The trap has two internal partitions made of a net-like material in the form of a funnel shape with the larger opening of the funnel shape being attached to the bottom and long sides of the trap and the smaller opening of the funnel shape attached to the sides of the trap creating multiple compartments. The long side panels each have an entrance opening also made of similar, net-like material forming a funnel to the inside of the trap. The partitions and the entrance openings are of such a design so as to make it extremely difficult for lobsters to escape. One alternative design of the device includes the removal of internal partitions for smaller-scale versions of the trap, such that the collapsible trap may be used for recreational purposes or for the trapping of other types of marine life. In another version of the device the internal partitions as well as the entryways may be omitted so that a collapsible storage unit is provided to retain relatively large numbers of marine animals.

The U.S. Pat. No. 7,313,887B2 patent relates to a collapsible trap. The invention claims to be a collapsible trap used to capture crabs or other live animals. More particularly still, collapsible live animal traps that utilize one or more support members that are stable when assembled, yet easily collapsible.

The U.S. Pat. No. 5,218,781A patent relates to a collapsible commercial king crab pot with a one-piece net. The invention claims to be a collapsible crab pot structure comprising a crap pot frame with a removable unitary bag-like net therein secured to the frame by a rope framework within the bag-like net. The bag-like net can be made from a single piece of netting fabric according to a prescribed pattern. The frame has square parallel vertically-spaced similarly oriented congruent relatively-movable rigid top and bottom horizontally extending frame portions. The four respective corners of the top and bottom frame portions are interconnected by, and pivotably connected to, four post structures to form an essentially parallelpiped frame structure. A netting-covered door in a vertical front side of the frame structure is hinged along the front side of the top frame portion for swinging movement from a closed vertical position to a position atop the top frame portion. Convergent tunnel portions of the trap net enter the trap from opposite vertical sides which are perpendicular to the door side of the frame structure. The pivoting connections between the top and bottom frame portions and the vertical posts restrict collapsing movement to a swinging translational motion of the top frame portion relative to the bottom frame portion in the direction rearwardly away from the door side. Each vertical post swings rearwardly through an angle of 90 degrees. Removable railway rail sections are secured within the frame structure to provide extra weight for ballast.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), Applicant(s) will amend the specification to expressly recite the essential material that is incorporated by reference as allowed by the applicable rules.

### SUMMARY

The invention may be a collapsible lobster trap. The trap may be comprised of a frame, a netting structure, at least one external entrance opening, a bait cleat, an internal funnel, and an escape opening. The frame may be made of vertical and horizontal rods that form the edges of a rectangular prism, and internal rods that may distinguish the rectangular prism into two side-by-side compartments. A netting structure may be fixed to the frame, and may form the faces of the rectangular prism, as well as an internal wall that distinguishes two internal compartments, separated at the internal rods. An external entrance opening may be an open funnel shape from the external wall of a compartment into one of the compartments so that a lobster can pass through the external entrance opening into the trap. A bait cleat may attach to a rod on the inside same compartment as the external entrance opening leads the crab into, and can hold bait to lure in a lobster to the trap. An internal funnel may be a funnel from the compartment with the bait cleat to the other compartment, and may be embedded in the netting of the internal wall. An escape opening may be embedded into the netting of an external wall of the compartment that does not contain the bait cleat.

The trap may also include a mesh floor, which is fixed to the bottom of the horizontal rods that form the bottom face of the rectangular prism of the trap.

The trap may also include runners, which may be fixed to the bottom of the horizontal rods that form the bottom face of the rectangular prism of the trap.

The trap may also include filaments as connectors for the rods.

The trap may also include a ghost hatch, which is embedded into an external wall of the second compartment. Additionally, the escape opening may be attached to the netting with a biodegradable material to give it a dual purpose of being an escape hatch and a ghost panel.

Further, the external entrance opening may made of the same material as the netting structure, and may include a ring to keep the external entrance opening open. At least one filament may be fixed to the ring and to a rod that opposes the external entrance opening, pulling the external entrance opening taught.

Further, the trap may contain an additional external entrance openings that may comprise the same elements as the original external entrance opening. The two external entrance openings may be affixed within the external walls of the first compartment that are parallel to each other. The external entrance openings may enter the trap towards each other. Both external entrance openings may be made of the same netting as the netting structure, and the may both contain rings to keep the external entrance openings open. The rings of the external entrance openings may be fixed to at least one filament, and the filament pulls the external entrance openings taught towards each other.

Further, the inner funnel may made of the same material as the netting structure, and may include a ring to keep the inner funnel open. At least one filament may be fixed to the ring and to an external rod of the second compartment, pulling the inner funnel taught.

The invention may also be a method for assembling a collapsible lobster trap. A frame is assembled a plurality of vertical and horizontal base rods, which may be coupled at the ends of the vertical base rods and horizontal base rods, forming external joints. Inner rods may additionally be coupled to a set of parallel horizontal base rods, forming inner joints and distinguishing the trap into a first compartment and a second compartment. A netting structure may be fixed to the frame, forming a plurality of external walls of the trap and an inner wall of the trap. At least one external entrance opening may be fixed within an external wall of the first compartment. An inner funnel may also be fixed within the inner wall of the trap. An escape opening may additionally be fixed within an external wall of the second compartment.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventor is fully aware that he can be his own lexicographer if desired. The inventor expressly elects, as his own lexicographers, to use only the plain and ordinary meaning of terms in the specification and claims unless he clearly states otherwise and then further, expressly sets forth the “special” definition of that term and explains how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventor not to invoke the provisions of 35 U.S.C. § 112(f). Moreover, even if the provisions of 35 U.S.C. § 112(f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DETAILED DESCRIPTION and DRAWINGS, and from the CLAIMS.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1. depicts a perspective top-down view of the trap in an assembled configuration with the netting structure.

FIG. 2 depicts a perspective side view of the trap in an assembled configuration with the netting structure.

FIG. 3 depicts a perspective view of the trap in an assembled configuration, without the netting structure shown.

FIG. 4 depicts a perspective view of the trap in a possible collapsed configuration.

FIG. 5 depicts perspective views of the trap in a different possible collapsed configuration.

FIG. 6 depicts a perspective top-down view of the trap in an assembled configuration and trapping a lobster.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

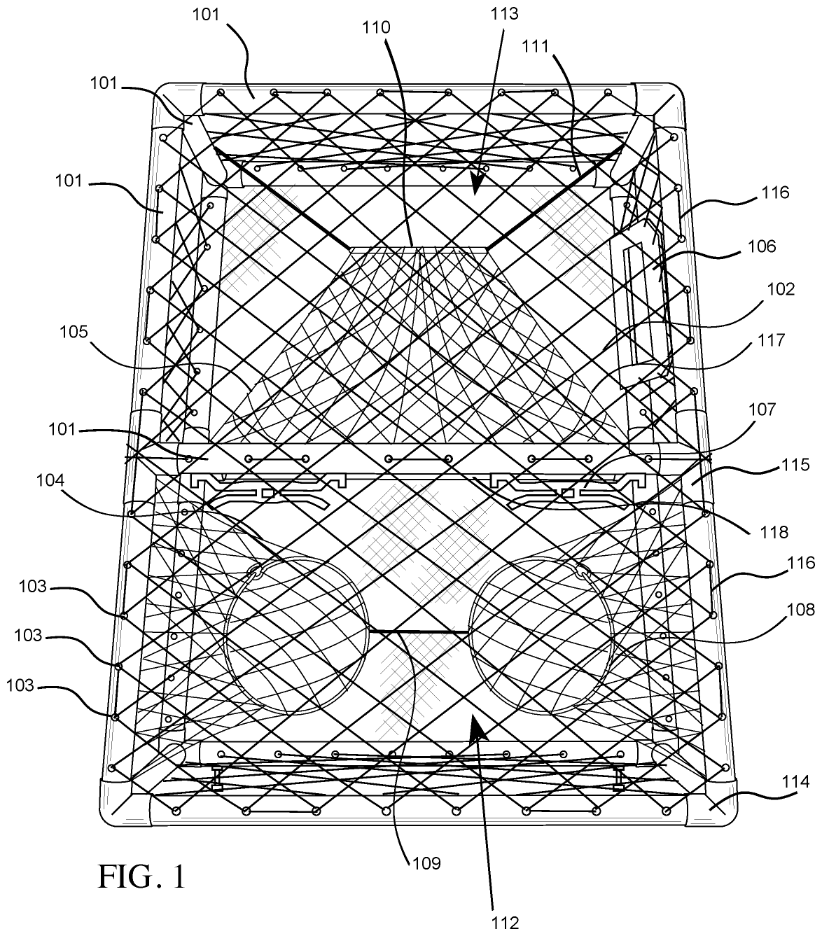

FIG. 1 shows the top-down view of an exemplary embodiment of the assembled lobster trap such that the collapsible lobster trap may comprise a frame 310, a netting structure 102, an external entrance opening 104, a bait cleat 107, an inner funnel 105, and an escape opening 106. One or more embodiments may additionally include optional features, including a mesh floor 306, a plurality of runners 307, and a plurality of bungee anchors 308.

The frame 310 may be a rectangular prism structure comprising a plurality of rods 101, and may be made of metal, plastic, or any other water-safe material having sufficient rigidity to serve as a frame. The rods may be solid or hollow. The frame may comprise base rods 201, such that the base rods 201 may be coupled to each other at the ends 401 of the rods, forming a plurality of external joints 114. In the present embodiment, the base rods 201 may be coupled to each other at the external joints 114 at 90-degree angles. The base rods 201 may also couple to each other at external joints 114 at angles other than 90 degrees. The base rods 201 can further be distinguished into vertical base rods 302, which are substantially perpendicular to the surface that the trap rests on, and horizontal base rods 301 that are substantially parallel to the surface that the trap rests on. The frame 310 may also include inner rods 303, which form an additional rectangle vertically between two sides of the frame 310. The inner rods 303 may differentiate the frame 310 into two compartments, a first compartment 112 and a second compartment 113. The inner rods 303 may form additional inner joints 115 with the horizontal base rods 301 of the frame 310. All rods 101, including the base rods 201 and the inner rods 303 may be coupled and uncoupled from each other at the external joints 114 and inner joints 115. If the rods 101 are uncoupled from each other at the joints 114 and 115, the trap disassembles and may be in a collapsed configuration.

In present embodiment, the joints 114 and 115 may couple the rods 101 together with fittings 205. The fittings 205 may couple the rods 101 by accepting the diameter of the rod into a hollow opening 506. The fittings 205 may be made of metal, plastic, or any other water-safe durable material. The base rods 201 may join together with socket x socket x socket “elbow” fittings 304 (hereinafter elbow fitting) which is a fitting with three hollow openings 506, with each hollow opening 506 at 90-degree angles with the other two openings. The inner rods 303 may join with the horizontal base rods 301 with a 4-way socket “tee” fitting 305 (hereinafter tee fitting), which is a fitting with four hollow openings 506, such that two of the openings are at 180-degree angles with each other, and the other two openings are each at 90-degree angles with all of the other openings. In this embodiment, the horizontal base rods 301 that may be included in the inner joints 115 may comprise two separate smaller rods 206 that fit into opposing sides of the tee fitting 305.

When a plurality of the base rods 201 and inner rods 303 are joined, the frame 310 may be in an assembled configuration. The rods 101 may stay joined or be disassembled in any configuration to collapse the trap and enable portability.

The netting structure 102 may be a flexible netting 402 that can affix to the frame 310 temporarily or permanently. The netting structure 102 may be permanently fixed to the frame 310 along some rods 101 and joints 114 and 115, and temporarily fixed to other rods 101 in any configuration that may be necessary to collapse the trap. The netting structure 102 may also be temporarily affixed to some or all of the rods 101, or permanently fixed to some or all of the rods 101. In the present embodiment, the rods 101 may have a plurality of holes 103 that the netting structure 102 may feed through for the netting structure 102 to be fixed. Further, the holes 103 may have a string 116 threaded between the holes 103, and the string 116 may loop through parts of the netting structure 102 to affix the netting structure 102 to the rods 101. The string 116 may be comprised of wire, rope, thread, twine, or any other flexible filament. The netting structure 102 may be a flexible netting 402 that forms walls 202 for the trap to distinguish the interior space 312 from the outside of the trap by forming a plurality of external walls 203. The interior space 312 may also be the inside of the rectangular prism that may be formed by the frame 310. When temporarily fixed to the frame 310, the netting structure 102 may be attached with any fastener, including but not limited to hooks and clasps. The netting structure 102 may be flexible plastic, rope, string, or any other water-safe flexible, insoluble material. The netting structure 102 may also distinguish the two compartments 112 and 113 of the trap, the first compartment 112 and the second compartment 113 by forming an inner wall 204. The inner wall may be distinguished into a first side 118 of the inner wall and a second side 117 of the inner wall 204 located opposite the first side 118 of the inner wall 204. The first compartment 112 may be located on the same side of the interior space 312 as the first side 118 of the inner wall 204. The second compartment 113 may be located on the same side of the interior space 312 as the second side 117 of the inner wall 204. The inner wall 204 may be a continuous portion of netting 402 within the external walls 203, or may be independent. The inner wall 204 may be affixed to the inner rods 303. The part of the netting structure 102 that forms the walls 202 may be continuous from one wall to another or may be independent from other parts of the netting structure 102 and be for only one wall. The netting structure 102 may comprise any combination of independent panels for individual walls and continuous panels for two or more walls. The netting structure 102 may block every rectangular side opening of the frame's 310 rectangular prism structure without gaps that a lobster could fit through, but there may be openings in the netting structure 102 for the external entrance opening 104 or the escape opening 106. The netting structure 102 may also be attached in a panel between the inner rods 303, with an opening for the inner funnel 105.

The external entrance opening 104 may comprise an elongated tunnel 209 which may contain an opening 207 from the outside of the trap to the inside of the first compartment 112. The external entrance opening 104 may be affixed within an opening in the external wall 203 and may extend into the first compartment 112. There may be one external entrance opening 104 to the first compartment 112, or a plurality of external entrance openings 104 into the first compartment 112. The external entrance opening 104 may be comprised of any material that allows the external entrance opening to extend into the first compartment and remain open, including rigid materials, or flexible materials. The external entrance opening 104 is suspended toward the inside of the first compartment 112, and in some embodiments, does not touch the bottom of first compartment 112, so that lobsters may enter the trap through the external entrance opening 104, but may not exit through the external entrance opening 104. The external entrance opening may be large enough for a lobster to fit through.

In one embodiment, shown in FIG. 1, the external entrance opening 104 may be comprised of the same material as the netting structure 102, extending inward from the external wall 203 into the first compartment 112, with a ring 108 holding the opening 104 apart to allow a lobster to fit through, and one or more filaments 109 pulling the ring 108 toward the opposite external wall 203 to keep the netting 402 taught. The ring 108 may be made of metal, plastic, or any other water-safe rigid material, and may be circular or any other open shape. The filament 109 may be, but is not limited to wire, rope, string, or chain. In the present embodiment of FIG. 1, two vertical opposite external walls 203 that are perpendicular to the inner wall 204 of netting structure 102 of the first compartment 112 may each contain an external entrance opening 104 which extend toward each other, and the rings 108 of the external entrance openings 104 may be pulled together by the filament 109 to make the netting 402 taught.

The bait cleat 107 is a fastener that allows the user to fix lobster bait to the inside of the first compartment 112 of the trap. The bait cleat 107 may be made of metal, plastic, or any other rigid water-safe material, or semi-flexible water-safe material what would hold a piece of bait. The bait cleat 107 may be, but is not limited to, a hook, clip, clamp, clasp, or cage. The bait cleat 107 may be attached to any rod that forms the first compartment 112, and is fixed so that it is located inside of the first compartment 112. In one exemplary embodiment, the bait cleat 107 may be affixed to the inner rod 303 on the roof of the trap 309. There may be one or more bait cleats 107. The bait cleat may be either permanently or temporarily fixed to any rod that comprises the first compartment 112. The bait cleat 107 may keep the bait in-place, preventing the bait from floating away from the trap, and luring lobsters to the inside of the trap.

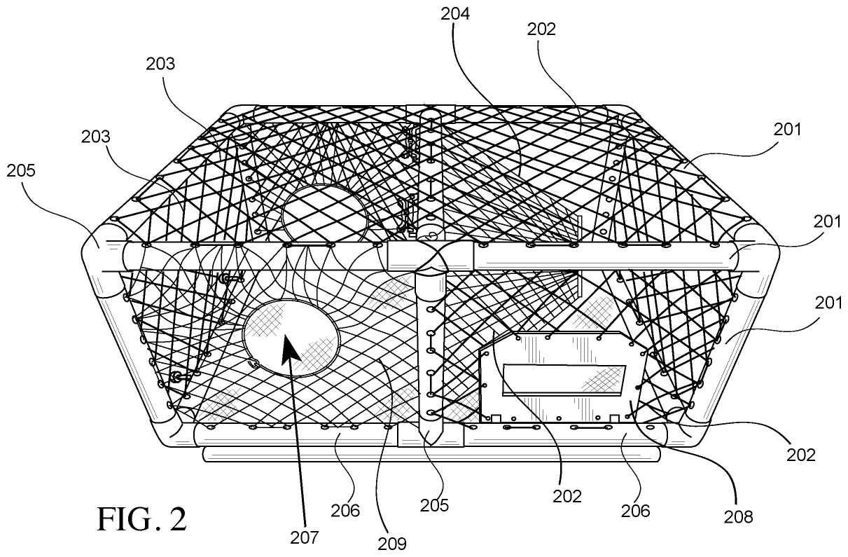

The inner funnel 105 may be an elongated tunnel 209 which may contain an opening 207 that extends from the first compartment 112 into the second compartment 113 of the trap. The inner funnel 105 may be affixed within an opening of the inner wall 204. The inner funnel 105 may be comprised of any material that allows the inner funnel 105 to extend into the second compartment 113 from the first compartment 112 and remain open, including rigid materials, or flexible materials. In some embodiments, the opening of the inner funnel 105 may not touch the bottom of second compartment 113, so that lobsters may enter the second compartment 113 from the first compartment 112 through the inner funnel 105, but may not return to the first compartment 112 via the inner funnel 105. The opening of the inner funnel 105 may be large enough for a lobster to fit through. Further, the inner wall 204 may solely comprise the inner funnel 105 when a funnel opening between the first compartment 112 and the second compartment 113 is the size of the inner wall 204, as shown by FIG. 2.

In the embodiment shown by FIG. 1, the inner funnel 105 may be comprised of the same netting 402 as the netting structure 102, extending into the second compartment 113 from the first compartment 112, with a ring 110 holding the opening apart, and one or more filaments 111 pulling the ring 110 toward the external wall 203 that is parallel to the inner wall 204 to keep the inner funnel 105 taut. The ring 110 may be made of metal, plastic, or any other water-safe rigid material, and may be circular or any other open shape. The filament 111 may be, but is not limited to wire, rope, string, or chain.

FIG. 2 shows a side view of the same exemplary embodiment as FIG. 1 such that the trap may be in an assembled configuration. This view of the trap depicts the escape opening 106, which may be an open structure that is embedded into the netting 402 of any vertical external wall 203 of the second compartment 113. The escape opening 106 may be a structure that keeps open a space in the netting structure 102, and the space may be large enough to pull a lobster out therethrough. The escape opening 106 may be made from metal, plastic, or any water-safe, insoluble material. The escape opening 106 may be made of a material that is rigid, or a material that is semi-flexible that allows the escape opening 106 to remain open. The escape opening 106 may be rectangular, as in the present embodiment, or any other shape. The escape opening 106 may be present to allow lobsters to be removed from the trap.

FIG. 2 may additionally include a ghost panel 207. The ghost panel 207 may be a rigid structure that biodegrades or dissolves over time, and may be located within an external wall 203 of the second compartment 113. The ghost panel 207 may be comprised of any water-safe material that biodegrades or dissolves over time, so that the trap will eventually have an opening that a lobster could escape from if the trap may be lost at sea. When the ghost panel 207 dissolves or biodegrades, there will be an opening left in the netting structure 102 that a lobster could escape through. The ghost panel 207 may be large enough so that once dissolved, a lobster can fit through the open space in the net. Additionally, the ghost panel 207 may be at an accessible height to a lobster, so that a lobster may escape if the ghost panel 207 biodegrades and leaves an opening in the netting structure 102. Further, the ghost panel 207 may be independent from or integrated with the escape opening 106. If integrated with the escape opening 106, the ghost panel 207 may comprise the escape opening 106 because the escape opening 106 may be attached to the netting structure 102 with a biodegradable material. The escape opening 106 may additionally be a ghost panel 207 if the escape opening 106 is made of biodegradable of dissolvable material.

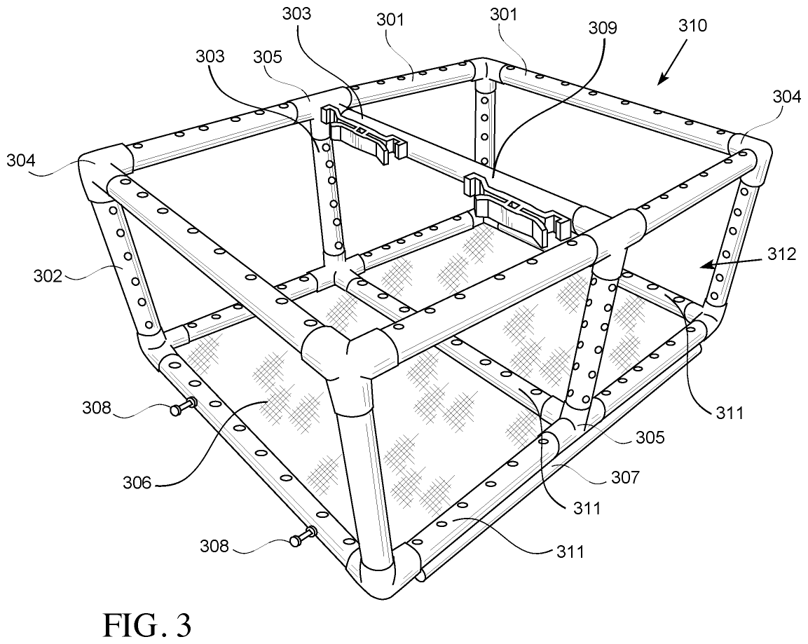

FIG. 3 further depicts a corner view of the embodiment of FIG. 1 and FIG. 2, without the netting structure 102 shown. FIG. 3 additionally includes a plurality of runners 307. The runners 307 may be rigid rods that may be coupled to the bottom of lower horizontal rods 311 at the bottom of the trap, and may run parallel to either set of bottom rods of the trap. The runners 307 may be made of wood, metal, plastic, or any other water-safe rigid material, or any water-safe semi-flexible material that can allow the runners to hold the trap up off of the surface that the trap is resting on. The runners 307 may be present to prevent damage to the trapped lobsters' claws, and help the trap run smoothly along the sea floor when the trap is being pulled to the surface of the water by the user.

FIG. 3 additionally includes a mesh floor 306. The mesh floor 306 may be a mesh material that is coupled to the four lower-most rods that are at the bottom lower horizontal rods 311. The mesh floor 306 may be comprised of mesh that may be metal, plastic, or any other flexible water-safe material. The mesh that the mesh floor 306 may be comprised of may be any size, so long as the openings in the mesh are smaller than the openings in the netting 402 that the netting structure 102 may be comprised of. The mesh floor 306 may be fixed to the lower horizontal rods 311 either permanently or temporarily. The mesh floor 306 may be permanently fixed to some rods, and temporarily fixed to others, and may be permanently or temporarily fixed to the lower horizontal rods 311 in any configuration. The mesh floor 306 may be present in conjunction with the runners 307, or in the absence of the runners 307. The mesh floor 306 is present to prevent injury to the lobsters' claws when a trap is pulled to the surface of the water by the user.

As shown in FIG. 3, some embodiments may additionally include a plurality of bungee anchors 308. The bungee anchors 308 may be fixtures that extend outward from any horizontal base rod 301. The bungee anchors may be made from metal, plastic, or and other water-safe rigid material. The bungee anchors 308 may be, but are not limited to, nail, screws, hooks, or clasps. The bungee anchors 308 may be present to help temporarily fix the trap to the bungee cords that often are present on single-user watercraft, such as kayaks, to transport the trap to and from the shore. The bungee anchors 308 may be present in conjunction with the runners 307, or in the absence of the runners 306. The bungee anchors may be present in conjunction with the mesh floor 306, or in the absence of the mesh floor 306.

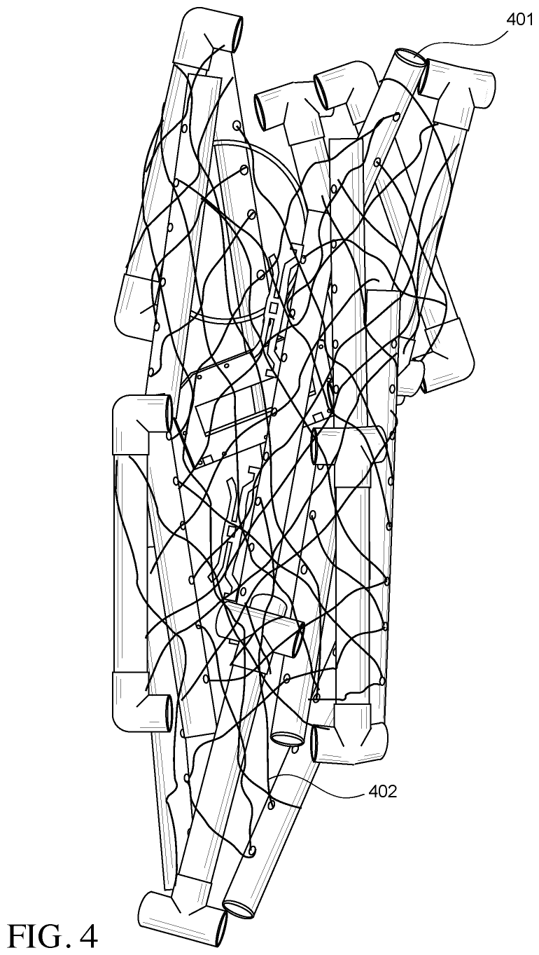

FIG. 4 depicts an exemplary embodiment of the trap when in a possible collapsed configuration. In that embodiment, the base rods and inner rods 303 may disassemble from each other at the external joints 114 and the inner joints 115, and the trap may be stored and transported with the rods 101 parallel to each other in a bundle. In that embodiment, netting structure 102 may be permanently fixed to all of the rods 101, and does not disconnect from any rod 101 when in that collapsed configuration. In this embodiment, the horizontal base rods 301 that may be included in the inner joints 115 may comprise two separate smaller rods 206 that fit into opposing sides of the tee fitting 305.

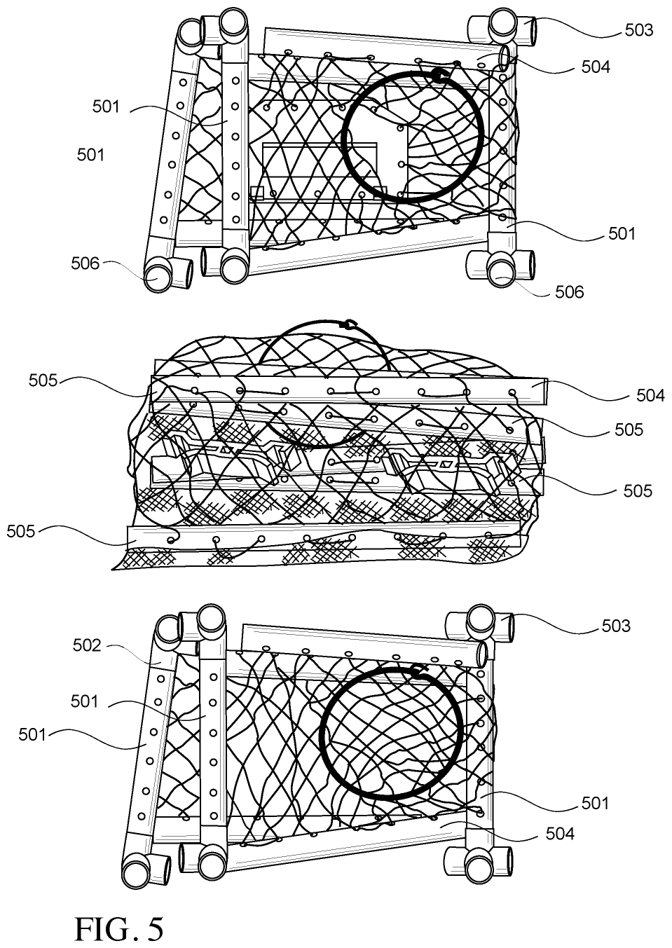

FIG. 5 depicts another exemplary embodiment of the collapsed trap. As shown, there are two external entrance openings 104 on opposite external walls 203 of the first compartment 112, and the escape opening 106 may be situated in one of the same walls 203 as one of the external entrance openings 104, but on the side of the wall 203 that encompasses the second compartment 113. When disassembled, the trap may be separated into three distinct sections shown in FIG. 5. In that embodiment, the rods 101 may all be coupled together with fittings. When the rods are all disassembled, the vertical rods 501 may remain permanently fixed to the elbow fittings 502 and the tee fittings 503, and the horizontal rods 504 may pull apart from the fittings 304, 305. The external walls 203 that contain the external entrance openings 104 are comprised of an independent portion of the netting structure 102 that is permanently affixed to rods 101 for those external walls 203. The remaining horizontal rods 505, which may not affix to the external walls 203 with external entrance openings 104, may all be parallel to each other when the trap is in the assembled configuration, and the part of the netting structure 102 that couples all of those rods may be independent from the other sections of the netting structure 102 and permanently affixed to those rods, may comprise the four remaining external walls 203 of the trap, and may comprise the inner wall 204 with the inner funnel 105 integrated into it. That section may also include the mesh floor 306 and runners 307 if present, as shown in FIG. 5. Two bait cleats 107 may be permanently affixed to a top internal rod 309, and may also be also included in that section, as seen in FIG. 5. When re-assembled, the edges of the netting structure 102 that are not permanently affixed to a rod may be temporarily affixed to that edge's respective rod. In this embodiment, the horizontal base rods 301 that may be included in the inner joints 115 may comprise two separate smaller rods 206 that fit into opposing sides of the tee fitting 305.

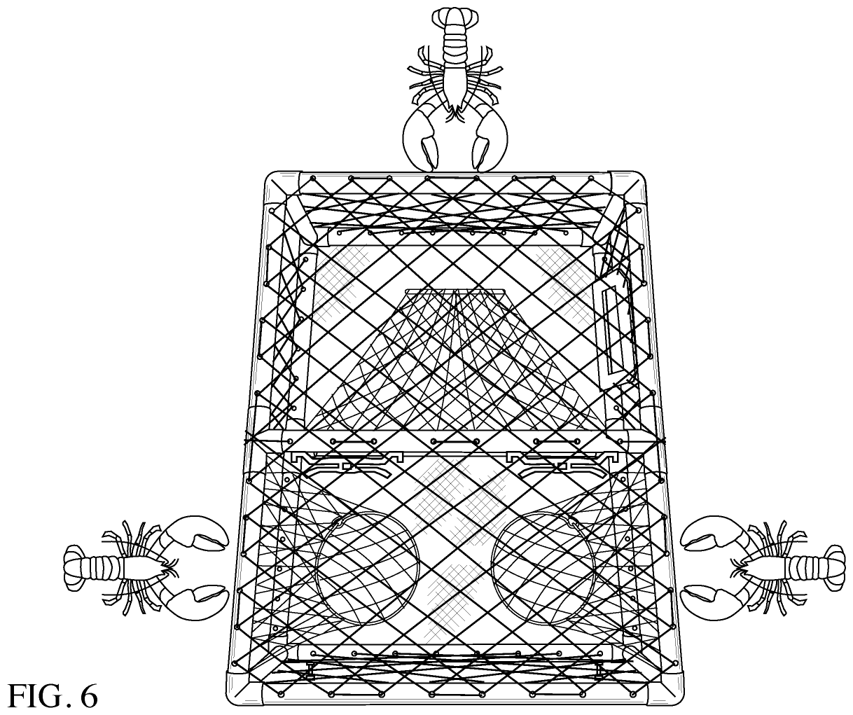

FIG. 6 depicts the trap when in use. FIG. 6 shows a lobster being trapped inside of the trap.

This invention over comes the prior art because other collapsible lobster traps do not combine portability with the elements explained above. This trap collapses to a much smaller size for use by lobster fishermen, while still including elements that are required by local standards. While some commercial crab pots have elements that pull apart or unlock from each other to collapse, the present invention remains much more portable due to the nature of the substantially straight rods, and has a unique structure that is not present in the prior art for crab pots.

I claim:

1. A collapsible lobster trap comprising:
a frame comprising:
a plurality of horizontal base rods;
a plurality of vertical base rods coupled to the plurality of horizontal base rods via a plurality of external joints thereby forming a rectangular prism; and
a plurality of inner rods coupled to the horizontal base rods between the vertical base rods at a plurality of inner joints, wherein the base rods and the inner rods are all configured to couple and uncouple from each other at the external joints and at the inner joints;
a netting structure affixed to the frame, forming a plurality of external walls configured to encapsulate an interior space formed by the frame; and
an inner wall configured to separate the interior space into a first compartment and a second compartment, wherein the first compartment is located on a first side of the inner wall within the interior space and the second compartment is located on a second side of the inner wall within the interior space, the second side of the inner wall being located opposite the first side of the inner wall, wherein the inner wall is affixed to the inner rods;
a first external entrance opening within at least one of the external walls of the first compartment, wherein the external entrance opening is configured to form a tunnel through the external wall to the first compartment;
at least one bait cleat within the first compartment, wherein the bait cleat is engaged with at least one of the external rods of the first compartment and at least one of the inner rods of the first compartment;
an inner funnel within the inner wall, wherein the inner funnel is configured to form a tunnel from the first compartment to the second compartment, and
an escape opening within at least one of the external walls of the second compartment.

2. The collapsible lobster trap of claim 1 wherein a mesh floor is affixed to a plurality of horizontal base rods substantially underneath the trap.

3. The collapsible lobster trap of claim 1 wherein a plurality of runners is affixed to a plurality of horizontal base rods substantially underneath the collapsible lobster trap.

4. The collapsible lobster trap of claim 1 wherein a plurality of bungee anchors is affixed to at least one external rod.

5. The collapsible lobster trap of claim 1 wherein at least one of the external walls of the second compartment comprises a ghost panel.

6. The collapsible lobster trap of claim 5 wherein the escape opening is affixed to at least one of the external walls of the second compartment with a biodegradable material to create the ghost panel.

7. The collapsible lobster trap of claim 1 wherein the vertical base rods and the horizontal base rods are coupled together with elbow fittings, and the inner rods are coupled to the respective horizontal base rods with tee fittings.

8. The collapsible lobster trap of claim 1 wherein the first external entrance opening comprises:
netting;
a ring affixed to the netting at an opening of the tunnel; and
at least one filament affixed to the ring, wherein the filament is configured to pull the netting substantially taut.

9. The collapsible lobster trap of claim 8 further comprising a second external entrance opening comprising:
netting;
a ring affixed to the netting at an opening of the tunnel; and
at least one filament affixed to the ring, wherein the filament is configured to pull the netting substantially taut.

10. The collapsible lobster trap of claim 9, wherein the first external entrance opening and the second external entrance opening are within opposite external walls of the first compartment, wherein the ring of the first external entrance opening and the ring of the second external entrance opening are coupled with one or more filaments.

11. The collapsible lobster trap of claim 1 wherein the inner tunnel comprises:
netting,
a ring affixed to the netting at an opening of the tunnel; and
at least one filament affixed to the ring, wherein the filament is configured to pull the netting substantially taut.

12. A method for assembling a collapsible lobster trap comprising:
assembling a frame by:
coupling a plurality of horizontal base rods and a plurality of vertical base rods via a plurality of external joints, thereby forming a rectangular prism; and
coupling a plurality of inner rods to the horizontal base rods between the vertical base rods at a plurality of inner joints, wherein the base rods and the inner rods are all configured to couple and uncouple from each other at the external joints and at the inner joints;
affixing a netting structure to the frame forming a plurality of external walls configured to encapsulate an interior space formed by the frame, the netting structure forming an inner wall configured to separate the interior space into a first compartment and a second compartment, wherein the first compartment is located on a first side of the inner wall within the interior space and the second compartment is located on a second side of the inner wall within the interior space, the second side of the inner wall being located opposite the first side of the inner wall, wherein the inner wall is affixed to the inner rods;
affixing at least one external entrance opening within at least one of the external walls of the first compartment, wherein the external entrance opening is configured to form a tunnel through the external wall to the first compartment;
affixing an inner funnel within the inner wall, wherein the inner funnel is configured to form a tunnel from the first compartment to the second compartment;
affixing an escape opening within one of the external walls of the second compartment.

13. The method of claim 12 further comprising:
affixing at least one bait cleat to at least one of the external rods of the first compartment and the inner rods of the first compartment, wherein the bait cleat is engaged within the first compartment.

14. The method of claim 12 further comprising:
affixing a mesh floor to a plurality of horizontal base rods, wherein the mesh floor is substantially underneath the trap.

15. The method of claim 12 further comprising:
affixing a plurality of runners to a plurality of horizontal base rods substantially underneath the collapsible lobster trap.

16. The method of claim 12 further comprising:
affixing a ghost panel within at least one external wall of the second compartment.

17. The method of claim 16 further comprising:
affixing the escape opening to at least one of the external walls of the second compartment with a biodegradable material to create the ghost panel.

18. The method of claim 12 further comprising:
coupling the vertical base rods and the horizontal base rods together with elbow fittings; and
coupling the inner rods are coupled to the respective horizontal base rods with tee fittings.

19. The method of claim 12, wherein the external entrance opening further comprises:
netting;
a ring affixed to the netting at an opening of the tunnel; and
at least one filament affixed to the ring, wherein the filament is configured to pull the netting substantially taut.

20. The method of claim 12, wherein the inner funnel further comprises:
netting;
a ring affixed to the netting at an opening of the tunnel; and
at least one filament affixed to the ring, wherein the filament is configured to pull the netting substantially taut.
